(19) United States
(12) Patent Application Publication
(10) Pub. No.: US 2006/0128022 A1
(43) Pub. Date: Jun. 15, 2006

(54) Process control method and process control system

(75) Inventors: Akira Nagashima, Tokyo (JP); Tetsuya Ohtani, Tokyo (JP); Makoto Nakaya, Tokyo (JP); Gentaro Fukano, Tokyo (JP)

Correspondence Address: EDWARDS & ANGELL, LLP, P.O. BOX 55874, BOSTON, MA, 02205, US

(73) Assignee: Yokogawa Electric Corporation, Tokyo (JP)

(21) Appl. No.: 11/301,839

(22) Filed: Dec. 12, 2005

(30) Foreign Application Priority Data
Dec. 14, 2004 (JP) 2004-360818

(51) Int. Cl. G05D 21/00

(52) U.S. Cl. 436/55

(57) ABSTRACT

A process control system has a data storage section which saves process data output from a sensor placed in a plant which performs a continuous process, a trace information processing section which acquires process information of a product moving in the plant and being discrete in a predetermined unit from the process data saved in the data storage section, a state estimation section which estimates a property of the discrete product based on the acquired process information, and a control section which controls a control apparatus placed in the plant so that an estimation value is closed to an objective value.

### CROSS-REFERENCE TO RELATED APPLICATIONS

This application is based upon and claims the benefit of priority from the prior Japanese Patent Applications No. 2004-360818, filed on Dec. 14, 2004, the entire contents of which are incorporated herein by reference.

### BACKGROUND OF THE INVENTION

1. Field of the Invention

This invention relates to a process control method relating to a continuous system process of a petroleum plant, a chemical plant, etc., and a process control system using the method.

2. Description of the Related Art

In a continuous system for inputting different types of materials and producing final products through a plurality of steps in a petroleum plant, a petrochemical plant, etc., the controlled variable for determining the quality of a product has been determined entirely based on time information (for example, temperature, flow rate, pressure, composition, etc.,) at each fixed point of the entrances and the exits of a reactor, an agitator, etc., and products have been manufactured.

FIG. 4 shows an example of the main configuration of a continuous system process in a related art. Material tanks 1 to 3 for blending nonuniform material and an intermediate tank 9 for temporarily storing products between steps are installed for suppressing fluctuation of the quality. The property of each product is analyzed with an analyzer 7, 11, etc., at all times in each step (reaction) for performing quality control.

For example, the publication of Japanese Patent No. 3152253 discloses the related art for installing the material tanks for blending nonuniform material and the intermediate tank for temporarily storing products.

Japanese Patent No. 3152253 (paragraphs 0014 to 0016 on page 3, FIG. 1) is referred to as a related art.

However, in the continuous system process for manufacturing final products through a plurality of steps in the related art, the installation area and the facility maintenance cost of the material tanks 1 to 3, the intermediate tank 9, etc., are issue to be solved. The quality control check of the property executed in each step also pushes up the manufacturing cost.

### SUMMARY OF THE INVENTION

An object of the invention is to provide a process control method and a process control system uniformed products are easily obtained without using any material tank or any intermediate tank, which are conventionally installed in a plant, in a continuous system wherein substance of fluid, slurry, powder, etc., flows continuously, substance is discrete in a predetermined unit, and control is performed with considering the past history for each unit.

The invention provides a process control method, including the steps of: saving process data output from a sensor placed in a plant which performs a continuous process, acquiring process information of a product moving in the plant and being discrete in a predetermined unit from the saved process data, estimating a property of the discrete product based on the acquired process information, and controlling a control apparatus placed in the plant so that an estimation value is closed to an objective value.

According to the process control method, the property of the product is estimated using a state estimation model and the control apparatus is controlled so as to bring the estimation value close to the previously specified objective value. Accordingly, elaborate operation can be performed and the property of the product can be easily uniformized without using any material tank or any intermediate tank for adjusting the quality as in the related art.

The invention also provides a process control system, having: a data storage section which saves process data output from a sensor placed in a plant which performs a continuous process; a trace information processing section which acquires process information of a product moving in the plant and being discrete in a predetermined unit from the process data saved in the data storage section; a state estimation section which estimates a property of the discrete product based on the acquired process information; and a control section which controls a control apparatus placed in the plant so that an estimation value is closed to an objective value.

According to the process control system, similar advantages to those of the process control method can also be provided.

In the process control system, the process information may be information of temperature, flow rate, or pressure.

The process control system may have a display section which displays an environment history trend of the product based on the process information acquired by the trace information processing section. In this case, useful information can be provided for the field operator.

The process control system may have a simulator which simulates process data output from the sensor based on the process information acquired by the trace information processing section. In this case, the process control system can simulate the operation of the plant more precisely.

In the process control system, the simulator may predict a future temperature history of the product by the higher-speed operation than the actual time based on the process information acquired by the trace information processing section.

According to the process control method and the process control system, the following advantages are provided:

(1) A product in a continuous system process is discretized in one unit, elaborate operation is performed, and the property of the product is uniformized, so that the need for a material tank and an intermediate tank for adjusting the quality can be eliminated.

(2) A product in a continuous system process is discretized in one unit, and the state estimation section calculates the property of the product based on trace information as to the product is made of what material and is passed through what steps, so that the number of property analysis times can be decreased.

(3) Since the temperature history trend received by the discretized product can be displayed on the display section, more useful information can be easily provided for the field operator.

(4) The simulator for simulating the operation of the plant so as to follow the process history data of the product can be provided for easily predicting the future temperature history of the product by the higher-speed operation than the actual time.

### BRIEF DESCRIPTION OF THE DRAWINGS

FIG. 1 is a drawing of the configuration of the main part to show an embodiment of a process control system according to the invention;

FIGS. 2A to 2C are drawings to show how product A flows in a reactor;

FIG. 3 is a drawing to describe a utilization example of a temperature history trend; and

FIG. 4 is a drawing to show an example of the main configuration of a continuous system process in a related art.

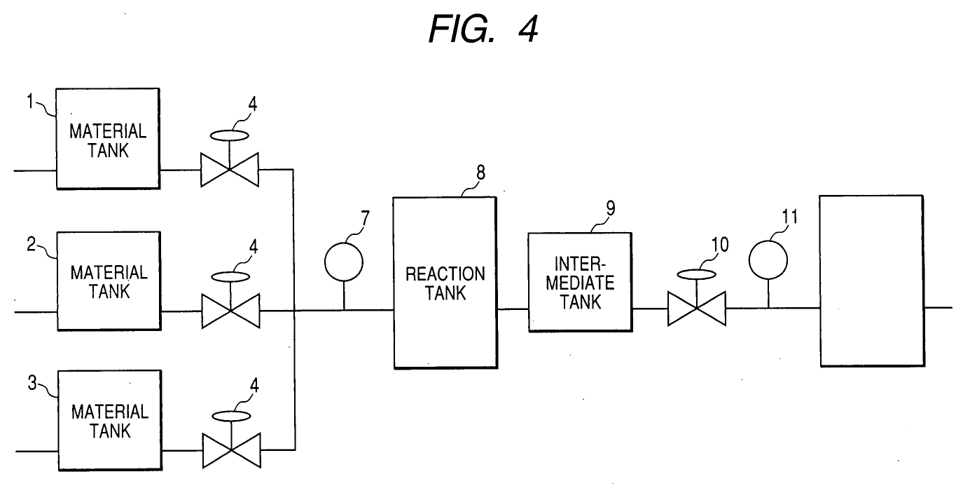

### DETAILED DESCRIPTION OF THE PREFERRED EMBODIMENTS

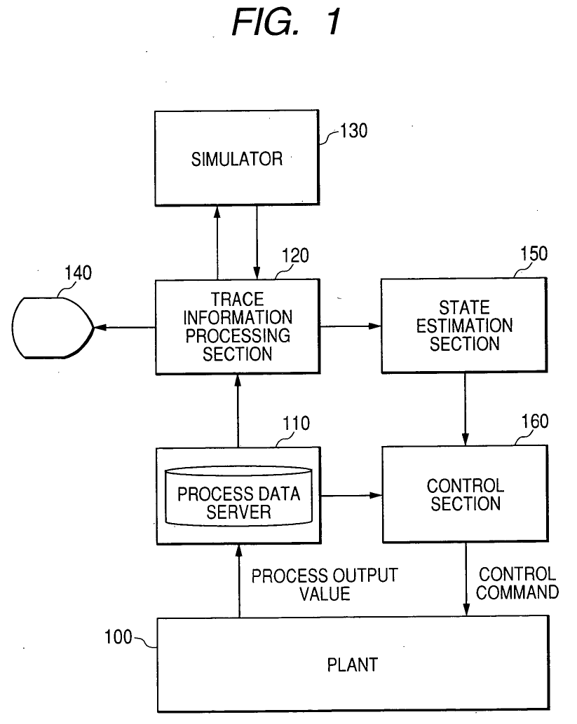

An embodiment will be discussed in detail with reference to the accompanying drawings. FIG. 1 is a drawing of the configuration of the main part to show one embodiment of a process control system according to the invention. The process control system shown in FIG. 1 has a plant 100, a process data server 110, a trace information processing section 120, a simulator 130, a display section 140, a state estimation section 150, and a control section 160.

Sensors (not shown) are placed at points in the plant 100, and output data of the sensors are saved in the process data server 110.

The trace information processing section 120 reads the output data of the sensors (process data) from the process data server 110 whenever necessary to acquire process information (temperature, flow rate, pressure, etc.,) of a product which moves in the plant 100 and is discrete in a predetermined unit.

The simulator 130 predicts a future temperature history of the product which is discrete in the unit by the higher-speed operation than the actual time based on the data of the trace information processing section 120.

The display section 140 displays trace information and an environment history trend, etc., of the process information saved in the trace information processing section 120 whenever necessary.

The state estimation section 150 estimates a property of the product, etc., from the process data which is discrete in the predetermined unit and is output from the trace information processing section 120. In other words, the state estimation section 150 calculates (estimates) the property of the product (quality information of viscosity, polymerization degree, etc.,) based on trace information as to the product is made of what material and is passed through what steps.

The estimation value of the property of the product estimated by the state estimation section 150 is sent to the control section 160. The control section 160 performs control operations for determining a control command (control parameter) so that the estimation value of the property is closed to a previously specified objective value, and transfers the control command (control parameter) to a control apparatus (not shown) placed in the plant 100.

Thus, in the embodiment, the product in the continuous system process is discrete in the predetermined unit, the property of the product (quality information) is estimated with using a state estimation model considering the history of the product with a move of the discrete produce to determine the control parameter in the following steps. Thus, the control apparatus in the plant 100 is controlled elaborately.

Accordingly, the property of the product is controlled to be uniform. Therefore, the material tanks and the intermediate tank for adjusting the quality used for the related art are entirely unnecessary.

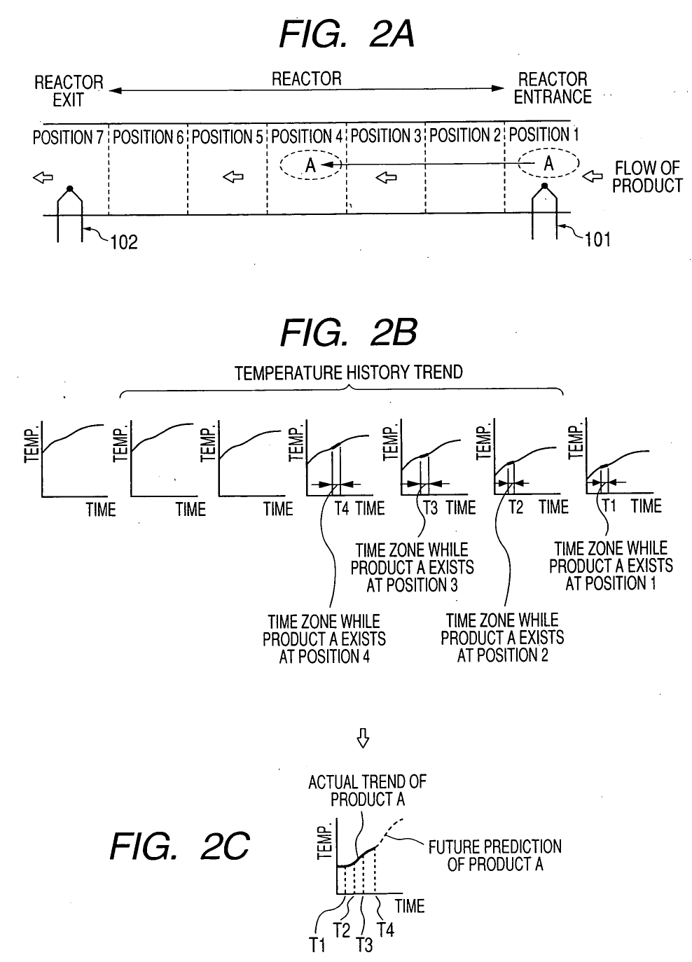

FIG. 2A is a drawing to show how product A flows in a reactor of the plant 100. Temperature sensors 101 and 102 are installed at the entrance and the exit of the reactor for measuring temperature. Positions 2 to 6 show the reactor inside, and the temperatures shown in FIG. 2B are a temperature history trend using the temperatures calculated by the simulator 130.

The simulator 130 predicts the future temperature history of the product by the higher-speed operation than the actual time based on the trace information acquired by the trace information processing section 120.

FIG. 2C shows the temperature history trend received by the product A until the product A moves in the reactor to position 4. The display section 140 displays such a temperature history trend. The dotted waveform after time T4 indicates the future prediction values of the product A found by the simulator 130.

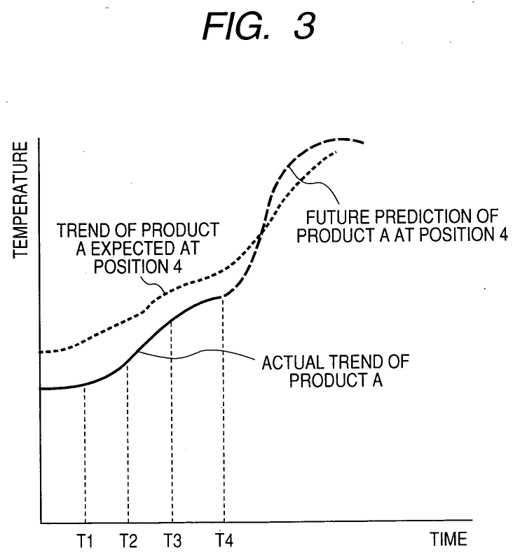

FIG. 3 is a drawing to describe a utilization example of the temperature history trend. In the example in FIG. 3, if the temperature history of the product A at position 4 largely differs from the past production result (temperature history shown as the trend of the product A expected at position 4), the temperature in the reaction step after position 4 is made higher than usual for improving the property of the product A, as shown in FIG. 3.

The invention is not limited to the specific embodiment described above and includes various changes and modifications without departing from the spirit and the scope of the invention.

What is claimed is:

1. A process control method, comprising the steps of:
saving process data output from a sensor placed in a plant which performs a continuous process,
acquiring process information of a product moving in the plant and being discrete in a predetermined unit from the saved process data,
estimating a property of the discrete product based on the acquired process information, and
controlling a control apparatus placed in the plant so that an estimation value is closed to an objective value.

2. A process control system, comprising:
a data storage section which saves process data output from a sensor placed in a plant which performs a continuous process;
a trace information processing section which acquires process information of a product moving in the plant and being discrete in a predetermined unit from the process data saved in the data storage section;
a state estimation section which estimates a property of the discrete product based on the acquired process information; and
a control section which controls a control apparatus placed in the plant so that an estimation value is closed to an objective value.

3. The process control system according to claim 2,
wherein the process information is information of temperature, flow rate, or pressure.

4. The process control system according to claim 2, further comprising:
a display section which displays an environment history trend of the product based on the process information acquired by the trace information processing section.

5. The process control system according to claim 2, further comprising:
a simulator which simulates process data output from the sensor based on the process information acquired by the trace information processing section.

6. The process control system according to claim 5,
wherein the simulator predicts a future temperature history of the product by the higher-speed operation than the actual time based on the process information acquired by the trace information processing section.
